(19) United States
(12) Patent Application Publication
(10) Pub. No.: US 2026/0197127 A1
(43) Pub. Date: Jul. 9, 2026

(54) SOUNDING REFERENCE SIGNAL TECHNIQUES WITH RECEIVER ANTENNA ADAPTION

(71) Applicant: QUALCOMM Incorporated, San Diego, CA (US)

(72) Inventors: Weimin DUAN, San Diego, CA (US); Hyojin LEE, San Diego, CA (US); Yu ZHANG, San Diego, CA (US); Gabi SARKIS, San Diego, CA (US); Le LIU, San Jose, CA (US)

(21) Appl. No.: 19/015,390

(22) Filed: Jan. 9, 2025

(51) Int. Cl. H04L 5/00; H04B 7/0404

(52) U.S. Cl. CPC H04L 5/0041; H04B 7/0404

(57) ABSTRACT

Methods, systems, and devices for wireless communications are described. A user equipment (UE) may transmit a control signal that indicates a subset of sounding reference signals (SRS) of a set of SRS. The UE may transmitting the set of SRS using a set of antenna ports of the UE. The subset of SRS may be transmitted using a subset of antenna ports of the set of antenna ports. The UE may receive, using the subset of antenna ports used to transmit the subset of SRS, a downlink control channel signal that is precoded according to the subset of SRS based on transmitting the set of SRS and the control signal that indicates the subset of SRS.

### FIELD OF TECHNOLOGY

The following relates to wireless communications, including sounding reference signal techniques with receiver antenna adaption.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting a control signal that indicates a subset of sounding reference signals (SRS) of a set of multiple SRS, transmitting the set of multiple SRS using a set of multiple antenna ports of the UE, where the subset of SRS is transmitted using a subset of antenna ports of the set of multiple antenna ports, and receiving, using the subset of antenna ports used to transmit the subset of SRS, a downlink control channel signal that is precoded according to the subset of SRS based on transmitting the set of multiple SRS and the control signal that indicates the subset of SRS.

A UE for wireless communications is described. The UE may include one or more memories storing processor executable code, and one or more processors coupled with the one or more memories. The one or more processors may individually or collectively be operable to execute the code to cause the UE to transmit a control signal that indicates a subset of SRS of a set of multiple SRS, transmit the set of multiple SRS using a set of multiple antenna ports of the UE, where the subset of SRS is transmitted using a subset of antenna ports of the set of multiple antenna ports, and receive, using the subset of antenna ports used to transmit the subset of SRS, a downlink control channel signal that is precoded according to the subset of SRS based on transmitting the set of multiple SRS and the control signal that indicates the subset of SRS.

Another UE for wireless communications is described. The UE may include means for transmitting a control signal that indicates a subset of SRS of a set of multiple SRS, means for transmitting the set of multiple SRS using a set of multiple antenna ports of the UE, where the subset of SRS is transmitted using a subset of antenna ports of the set of multiple antenna ports, and means for receiving, using the subset of antenna ports used to transmit the subset of SRS, a downlink control channel signal that is precoded according to the subset of SRS based on transmitting the set of multiple SRS and the control signal that indicates the subset of SRS.

A non-transitory computer-readable medium storing code for wireless communications is described. The code may include instructions executable by one or more processors to transmit a control signal that indicates a subset of SRS of a set of multiple SRS, transmit the set of multiple SRS using a set of multiple antenna ports of the UE, where the subset of SRS is transmitted using a subset of antenna ports of the set of multiple antenna ports, and receive, using the subset of antenna ports used to transmit the subset of SRS, a downlink control channel signal that is precoded according to the subset of SRS based on transmitting the set of multiple SRS and the control signal that indicates the subset of SRS.

Some examples of the method, UEs, and non-transitory computer-readable medium described herein may further include operations, features, means, or instructions for transmitting a second control signal that indicates an updated subset of SRS of the set of multiple SRS and receiving, using an updated subset of antenna ports of the set of multiple antenna ports that corresponds to the updated subset of SRS, a second downlink control channel signal that may be precoded according to the updated subset of antenna ports based on the second control signal that indicates the updated subset of SRS.

In some examples of the method, UEs, and non-transitory computer-readable medium described herein, the second control signal may be transmitted via radio resource control (RRC) signaling, uplink control information signaling, or a medium access control (MAC) control element (CE).

Some examples of the method, UEs, and non-transitory computer-readable medium described herein may further include operations, features, means, or instructions for transmitting capability information that indicates a capability of the UE to use the subset of antenna ports for downlink control channel reception.

In some examples of the method, UEs, and non-transitory computer-readable medium described herein, the capability information indicates a fixed mapping between the set of multiple SRS and the set of multiple antenna ports.

In some examples of the method, UEs, and non-transitory computer-readable medium described herein, the capability information indicates a first transmit-receive antenna configuration for a downlink control channel sounding and a second transmit-receive antenna configuration for a downlink shared channel sounding.

In some examples of the method, UEs, and non-transitory computer-readable medium described herein, the control signal indicates a first antenna group of a set of multiple antenna groups, the first antenna group corresponding to the subset of SRS.

In some examples of the method, UEs, and non-transitory computer-readable medium described herein, the control signal indicates a first antenna identifier of a first antenna group of a set of multiple antenna groups and a second antenna identifier of a second antenna group of the set of multiple antenna groups.

Some examples of the method, UEs, and non-transitory computer-readable medium described herein may further include operations, features, means, or instructions for transmitting a second control signal that indicates a second subset of antenna ports used for downlink control channel reception and receiving, using the second subset of antenna ports, a second downlink control channel signal that may be precoded according to the second subset of antenna ports.

In some examples of the method, UEs, and non-transitory computer-readable medium described herein, the second control signal indicates a quantity of antenna ports of the second subset of antenna ports.

In some examples of the method, UEs, and non-transitory computer-readable medium described herein, the second control signal indicates a mapping between the set of multiple antenna ports and the set of multiple SRS.

In some examples of the method, UEs, and non-transitory computer-readable medium described herein, a first quantity of bits in the control signal that indicates the subset of SRS implicitly indicates a second quantity of antenna ports in the subset of antenna ports.

Some examples of the method, UEs, and non-transitory computer-readable medium described herein may further include operations, features, means, or instructions for receiving control signaling that indicates SRS configuration information associated with a downlink control channel sounding, transmitting a second subset of SRS using a second subset of antenna ports based on the SRS configuration information associated with the downlink control channel sounding, and receiving a second control signal that may be precoded according to the second subset of SRS based on transmitting the second subset of SRS.

In some examples of the method, UEs, and non-transitory computer-readable medium described herein, the SRS configuration information associated with the downlink control channel sounding includes a first SRS periodicity that may be larger than a second SRS periodicity associated with the set of multiple SRS.

Some examples of the method, UEs, and non-transitory computer-readable medium described herein may further include operations, features, means, or instructions for receiving a trigger signal for transmission of the second subset of SRS, where transmitting the second subset of SRS may be based on the trigger signal.

In some examples of the method, UEs, and non-transitory computer-readable medium described herein, the control signaling indicates a subset of transmit antenna ports of a network entity, the second subset of antenna ports of the UE corresponding to the subset of transmit antenna ports of the network entity.

A method for wireless communications by a network entity is described. The method may include obtaining a control signal that indicates a subset of SRS of a set of multiple SRS, obtaining the set of multiple SRS, where the subset of SRS is transmitted using a subset of antenna ports of a set of multiple antenna ports of a UE, and outputting a downlink control channel signal that is precoded according to the subset of SRS based on obtaining the set of multiple SRS and the control signal that indicates the subset of SRS.

A network entity for wireless communications is described. The network entity may include one or more memories storing processor executable code, and one or more processors coupled with the one or more memories. The one or more processors may individually or collectively be operable to execute the code to cause the network entity to obtain a control signal that indicates a subset of SRS of a set of multiple SRS, obtain the set of multiple SRS, where the subset of SRS is transmitted using a subset of antenna ports of a set of multiple antenna ports of a UE, and output a downlink control channel signal that is precoded according to the subset of SRS based on obtaining the set of multiple SRS and the control signal that indicates the subset of SRS.

Another network entity for wireless communications is described. The network entity may include means for obtaining a control signal that indicates a subset of SRS of a set of multiple SRS, means for obtaining the set of multiple SRS, where the subset of SRS is transmitted using a subset of antenna ports of a set of multiple antenna ports of a UE, and means for outputting a downlink control channel signal that is precoded according to the subset of SRS based on obtaining the set of multiple SRS and the control signal that indicates the subset of SRS.

A non-transitory computer-readable medium storing code for wireless communications is described. The code may include instructions executable by one or more processors to obtain a control signal that indicates a subset of SRS of a set of multiple SRS, obtain the set of multiple SRS, where the subset of SRS is transmitted using a subset of antenna ports of a set of multiple antenna ports of a UE, and output a downlink control channel signal that is precoded according to the subset of SRS based on obtaining the set of multiple SRS and the control signal that indicates the subset of SRS.

Some examples of the method, network entities, and non-transitory computer-readable medium described herein may further include operations, features, means, or instructions for obtaining a second control signal that indicates an updated subset of SRS of the set of multiple SRS and outputting a second downlink control channel signal that may be precoded according to the updated subset of SRS based on the second control signal that indicates the updated subset of SRS.

Some examples of the method, network entities, and non-transitory computer-readable medium described herein may further include operations, features, means, or instructions for obtaining capability information that indicates a capability of the UE to use the subset of antenna ports for downlink control channel reception.

In some examples of the method, network entities, and non-transitory computer-readable medium described herein, the capability information indicates a fixed mapping between the set of multiple SRS and the set of multiple antenna ports.

In some examples of the method, network entities, and non-transitory computer-readable medium described herein, the capability information indicates a first transmit-receive antenna configuration for a downlink control channel sounding and a second transmit-receive antenna configuration for a downlink shared channel sounding.

In some examples of the method, network entities, and non-transitory computer-readable medium described herein, the control signal indicates a first antenna group of a set of multiple antenna groups, the first antenna group corresponding to the subset of SRS.

In some examples of the method, network entities, and non-transitory computer-readable medium described herein, the control signal indicates a first antenna identifier of a first antenna group of a set of multiple antenna groups and a second antenna identifier of a second antenna group of the set of multiple antenna groups.

Some examples of the method, network entities, and non-transitory computer-readable medium described herein may further include operations, features, means, or instructions for obtaining a second control signal that indicates a second subset of antenna ports of the UE used for downlink control channel reception and outputting a second downlink control channel signal that may be precoded based on the second control signal that indicates the second subset of antenna ports of the UE.

In some examples of the method, network entities, and non-transitory computer-readable medium described herein, the second control signal indicates a quantity of antenna ports of the second subset of antenna ports.

In some examples of the method, network entities, and non-transitory computer-readable medium described herein, the second control signal indicates a mapping between the set of multiple antenna ports and the set of multiple SRS.

Some examples of the method, network entities, and non-transitory computer-readable medium described herein may further include operations, features, means, or instructions for determining a second quantity of antenna ports in the subset of antenna ports based on a first quantity of bits in the control signal that indicates the subset of SRS.

Some examples of the method, network entities, and non-transitory computer-readable medium described herein may further include operations, features, means, or instructions for outputting control signaling that indicates SRS configuration information associated with a downlink control channel sounding, obtaining a second subset of SRS based on the SRS configuration information associated with the downlink control channel sounding, and outputting a second control signal that may be precoded according to the second subset of SRS.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports sounding reference signal (SRS) techniques with receiver antenna adaption in accordance with one or more aspects of the present disclosure.

FIG. 2 shows an example of a wireless communications system that supports SRS techniques with receiver antenna adaption in accordance with one or more aspects of the present disclosure.

FIG. 3 shows an example of a process flow that supports SRS techniques with receiver antenna adaption in accordance with one or more aspects of the present disclosure.

FIGS. 4 and 5 show block diagrams of devices that support SRS techniques with receiver antenna adaption in accordance with one or more aspects of the present disclosure.

FIG. 6 shows a block diagram of a communications manager that supports SRS techniques with receiver antenna adaption in accordance with one or more aspects of the present disclosure.

FIG. 7 shows a diagram of a system including a device that supports SRS techniques with receiver antenna adaption in accordance with one or more aspects of the present disclosure.

FIGS. 8 and 9 show block diagrams of devices that support SRS techniques with receiver antenna adaption in accordance with one or more aspects of the present disclosure.

FIG. 10 shows a block diagram of a communications manager that supports SRS techniques with receiver antenna adaption in accordance with one or more aspects of the present disclosure.

FIG. 11 shows a diagram of a system including a device that supports SRS techniques with receiver antenna adaption in accordance with one or more aspects of the present disclosure.

FIGS. 12 and 13 show flowcharts illustrating methods that support SRS techniques with receiver antenna adaption in accordance with one or more aspects of the present disclosure.

### DETAILED DESCRIPTION

A wireless communications system may support techniques for a user equipment (UE) to reduce power consumption. For example, a UE may monitor for downlink control channel signaling from a network entity using a reduced set of antenna ports. Monitoring using the reduced set of antenna ports may decrease power consumption at the UE compared to monitoring for control channel signaling using a larger quantity of antenna ports. However, using a reduced quantity of antenna ports to receive control channel signaling may reduce downlink control channel decoding performance. For example, block error rate may increase when the UE uses two antenna ports to receive downlink control channel signaling compared to when the UE uses four antenna ports to receive downlink control channel signaling.

Wireless communications systems described herein may support techniques for physical downlink control channel (PDCCH) reception adaptation based on sounding reference signal (SRS) transmission. A UE may transmit SRS using each of a set of antenna ports of the UE. The UE may transmit an indication of the SRS that correspond to antenna ports the UE uses for PDCCH reception. For example, the UE may transmit four SRS using four antenna ports, and the UE may also transmit a control signal which indicates, for example by indicating a value of a bitmap, two SRS of the four SRS. The network entity may receive the SRS and the indication of the SRS, and the network entity may precode downlink control channel signaling according to the indicated SRS. For example, the network entity may precode downlink control channel signaling according to the two indicated SRS of the four received SRS. In some examples, the network entity may use a precoder matrix identity (PMI) associated with the indicated SRS to select a precoder for a transmit beam of the PDCCH signaling.

In some examples, a mapping between SRS and physical antennas at the UE may be fixed or dynamically changed. The UE may semi-statically or dynamically transmit an indication of an updated mapping, or an updated indication of SRS which correspond to antenna ports used for PDCCH reception, to the network entity. In some examples, the UE may receive PDCCH signaling based on groups of antenna ports of the UE, and the UE may transmit the indication of the SRS based on antenna port groups of the UE. In some examples, the UE may change a quantity of antenna ports the UE uses to receive PDCCH signaling, and the UE may transmit an indication of updated SRS to the network entity. In some examples, the network entity may configure the UE to transmit a SRS which is associated with, or used for, PDCCH sounding. For example, the UE may transmit the SRS associated with PDCCH sounding using antenna ports the UE uses for PDCCH reception. In some examples, the UE may report capability information associated with PDCCH sounding. For example, the UE may indicate whether the UE has a fixed or dynamically updated mapping between SRS and PDCCH reception antennas, or whether the UE supports using SRS for PDCCH reception adaptation.

Aspects of the disclosure are initially described in the context of wireless communications systems. Aspects of the disclosure are further illustrated by and described with reference to a process flow, apparatus diagrams, system diagrams, and flowcharts that relate to SRS techniques with receiver antenna adaption.

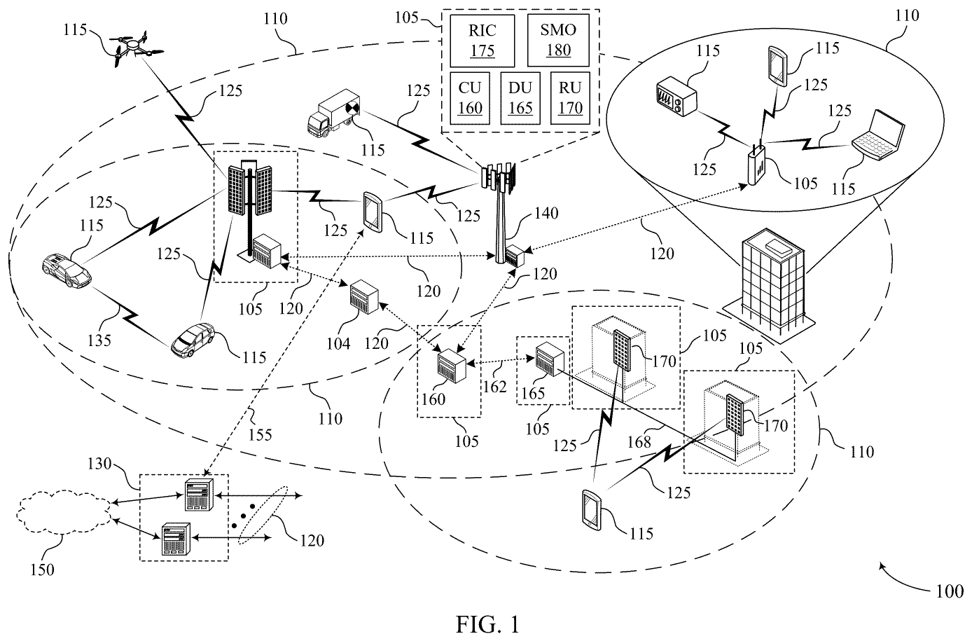

FIG. 1 shows an example of a wireless communications system 100 that supports SRS techniques with receiver antenna adaption in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support SRS techniques with receiver antenna adaption as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support techniques for a UE 115 to reduce power consumption. For example, a UE 115 may monitor for PDCCH signaling from a network entity 105 using a reduced set of antenna ports. For example, the UE 115 may report CSI with four antenna ports, then the UE 115 may reduce a quantity of receive antennas to two receive antennas. In some examples, the UE 115 may reduce a quantity of antennas and report CSI using the reduced quantity of antennas. For example, the UE 115 may switch to using two antenna ports to receive PDCCH signaling, and the UE 115 may report CSI using the two antenna ports. A network entity 105 may use a PMI or SRS corresponding to the receive antenna ports of a UE 115 to select a precoder or transmit beam to transmit the PDCCH signaling.

Monitoring for PDCCH signaling using the reduced set of antenna ports may decrease power consumption at the UE 115 compared to monitoring for PDCCH signaling using a larger quantity of antenna ports. However, using a reduced quantity of antenna ports to receive PDCCH signaling may reduce PDCCH decoding performance. In some examples, PDCCH link level performance may decrease when the UE 115 uses a reduced quantity of receive antennas. For example, block error rate may increase when the UE 115 uses two antenna ports to receive PDCCH signaling compared to when the UE 115 uses four antenna ports to receive PDCCH signaling.

Wireless communications systems described herein may support techniques for PDCCH reception adaptation based on SRS transmission. A UE 115 may transmit SRS using each of a set of antenna ports of the UE 115. The UE 115 may transmit an indication of the SRS that correspond to antenna ports the UE uses for PDCCH reception. For example, the UE 115 may transmit four SRS using four antenna ports, and the UE 115 may also transmit a control signal which indicates, for example by indicating a value of a bitmap, two SRS of the four SRS. The network entity 105 may receive the SRS and the indication of the SRS, and the network entity 105 may precode downlink control channel signaling according to the indicated SRS. For example, the network entity 105 may precode downlink control channel signaling according to the two indicated SRS of the four received SRS. In some examples, the network entity 105 may use a precoder matrix identity (PMI) associated with the indicated SRS to select a precoder for a transmit beam of the PDCCH signaling.

An alignment between the network entity 105 and the UE 115 may reduce performance loss that occurs from the UE 115 using a reduced set of antennas to receive PDCCH signaling. In some examples, these techniques may support enhanced downlink precoder or beam selection with semi-transparent PDCCH reception adaptation. The network entity 105 may use a PMI or SRS corresponding to the used receive antennas to select the precoder or transmit beam. Selecting the precoder or transmit beam based on the antenna ports used for PDCCH reception at the UE 115 may reduce link loss or improve PDCCH decoding performance at the UE 115.

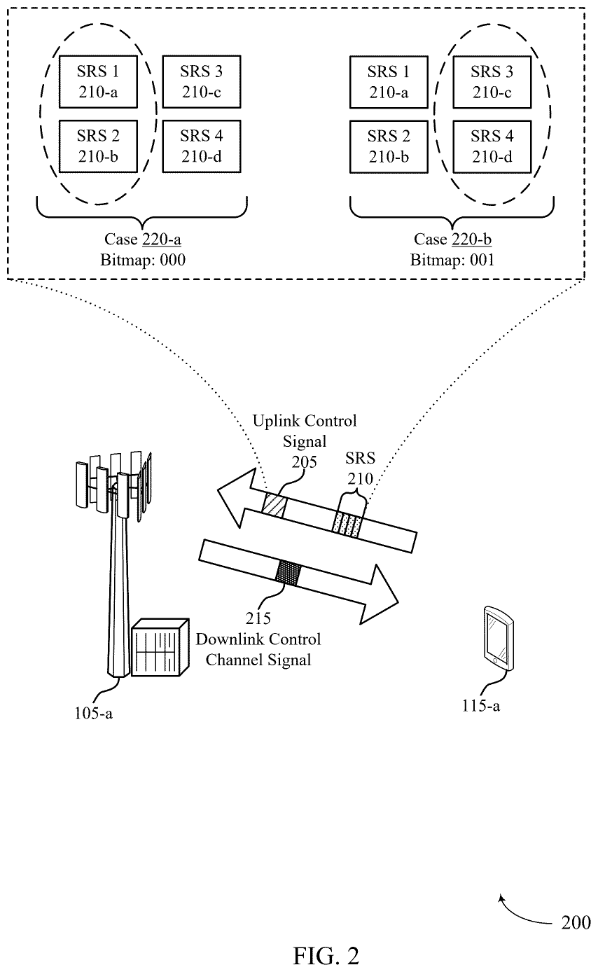

FIG. 2 shows an example of a wireless communications system 200 that supports SRS techniques with receiver antenna adaption in accordance with one or more aspects of the present disclosure. The wireless communications system 200 may implement aspects of a wireless communications system 100. For example, the wireless communications system 200 may include a UE 115-a and a network entity 105-a, which may be respective examples of a UE 115 and a network entity 105 as described herein.

The wireless communications system 200 may support techniques for PDCCH reception adaptation. For example, the UE 115-a be configured with a set of antenna ports, and the UE 115-a may use a reduced quantity of antenna ports form the set of antenna ports to receive PDCCH signaling from the network entity 105-a. For example, the UE 115-a may be equipped with four antenna ports, and the UE 115-a may use two antenna ports to receive PDCCH signaling from the network entity 105-a.

The wireless communications system 200 may support PDCCH reception adaptation based on SRS transmission from the UE 115-a. For example, the UE 115-a may transmit an uplink control signal 205 that indicates a subset of SRS 210 from a set of SRS 210. The indicated subset of SRS may correspond to receive antennas the UE 115-a uses to receive PDCCH signaling from the network entity 105-a. The network entity 105-a may receive the set of SRS 210 and select a precoder or transmit beam for a downlink control channel signal 215 (e.g., a PDCCH signal) based on the indicated subset of SRS 210.

For example, during an SRS-based sounding, the UE 115-a may indicate, to the network entity 105-a, which SRS antenna ports correspond to the receive antenna ports the UE 115-a uses for PDCCH monitoring. In a first case 220-a, the UE 115-a may use a first antenna port, used to transmit a first SRS 210-a, and a second antenna ports, used to transmit a second SRS 210-b, to monitor for PDCCH signaling from the network entity 105-a. The UE 115-a may transmit the uplink control signal 205 indicating the first SRS 210-a and the second SRS 210-b. The UE 115-a may transmit a set of SRS 210, including the first SRS 210-a, the second SRS 210-b, a third SRS 210-c, and a fourth SRS 210-d. The network entity 105-a may receive the set of SRS 210 and select a precoder for the downlink control channel signal 215 based on the first SRS 210-a and the second SRS 210-b. In some examples, the network entity 105-a may select the precoder for the downlink control channel signal 215 or a transmit beam for the downlink control channel signal 215 based on a PMI of the first SRS 210-a or the second SRS 210-b, or both.

In a second case 220-b, the UE 115-b may use a third antenna port, used to transmit the third SRS 210-c, and a fourth antenna port, used to transmit the fourth SRS 210-d, to monitor for PDCCH signaling from the network entity 105-a. The UE 115-a may transmit the uplink control signal 205 indicating the third SRS 210-c and the fourth SRS 210-d, and the UE 115-a may transmit the set of SRS 210. In the second case 220-b, the network entity 105-a may receive the set of SRS 210 and select a precoder or transmit beam for the downlink control channel signal 215 according to the third SRS 210-c and the fourth SRS 210-d. In other examples, the UE 115-a may use different combinations or different quantities of antenna ports, which may correspond to different SRS 210 or different combinations of SRS 210, to monitor for PDCCH signaling from the network entity 105-a, and the uplink control signal 205 may similarly indicate the different SRS 210 or different combinations of SRS 210.

In some examples, the uplink control signal 205 may include a bitmap which identifies different SRS transmitted by the UE 115-a. For example, a first value of the bitmap, shown for the first case 220-a, may be ‘000’. The first value of the bitmap may identify a first subset of SRS, including the first SRS 210-a and the second SRS 210-b. For example, the UE 115-a may transmit the uplink control signal 205 including the bitmap set to the first value to indicate that the UE 115-a uses the same antenna ports to monitor for PDCCH signaling and transmit the first SRS 210-a and the second SRS 210-b. In other examples, the bitmap indicated by the uplink control signal 205 may be set to other values to indicate different SRS 210 or different combinations of SRS 210.

In some examples, a mapping between values of the bitmap and the different SRS may be semi-statically configured, dynamically configured, statically configured, or preconfigured. For example, the network entity 105-a and the UE 115-a may each determine that the first value of the bitmap identifies the first SRS 210-a and the second SRS 210-b, and a second value of the bitmap, such as the bitmap being set to ‘001’ as shown by the second case 220-b, corresponds to the third SRS 210-c and the fourth SRS 210-d. For example, the network entity 105-a may configure a mapping between bitmap values and SRS 210, or the mapping between bitmap values and SRS 210 may be preconfigured for the wireless communications system 200.

In some examples, a mapping between SRS 210 and physical antennas of the UE 115-a may be fixed, semi-statically fixed, or dynamically changed. For example, the UE 115-a may change from transmitting the first SRS 210-a and the second SRS 210-b using the same antenna ports the UE 115-a uses to monitor for PDCCH signaling to transmitting the third SRS 210-c and the fourth SRS 210-d using the same antenna ports the UE 115-a uses to monitor for PDCCH signaling. The UE 115-a may semi-statically or dynamically transmit updates for the mapping or update the indicated SRS. For example, the UE 115-a may transmit the uplink control signal 205, or an uplink control signal which indicates an updated indication of SRS, via an uplink control information message, a MAC control element, or RRC signaling.

For example, at a first time, the UE 115-a may use a first antenna and a second antenna to transmit the first SRS 210-a and the second SRS 210-b, respectively, and the UE 115-a may use the first antenna and the second antenna to monitor for PDCCH signaling from the network entity 105-a. The UE 115-a may transmit a first uplink control signal to indicate a first value of the bitmap, such as for the first case 220-a shown by FIG. 2. The network entity 105-a may receive the set of SRS 210 and transmit PDCCH signaling to the UE 115-a that is precoded according to the first SRS 210-a and the second SRS 210-b based on the first uplink control signal. A mapping between SRS 210 and physical antennas at the UE 115-a may change, such that, at a second time, the UE 115-a uses the first antenna and the second antenna to transmit the third SRS 210-c and the fourth SRS 210-d, and the UE 115-a still uses the first antenna and the second antenna to monitor for PDCCH signaling from the network entity 105-a. The UE 115-a may transmit a second uplink control signal to indicate a second value of the bitmap, such as for the second case 220-b shown by FIG. 2. The network entity 105-a may receive the set of SRS 210 and transmit PDCCH signaling to the UE 115-a that is precoded according to the third SRS 210-c and the fourth SRS 210-d.

In some examples, the antenna ports used to receive PDCCH signaling may be changed, or the SRS ports corresponding to the antenna ports used to receive PDCCH signaling may be changed. For example, the UE 115-b may transmit the second control signal to indicate the second value of the bitmap and indicate the updated antenna ports used for PDCCH monitoring, or the UE 115-b may transmit the second control signal to indicate an updated mapping between SRS ports and antenna ports used for PDCCH monitoring.

In some examples, the SRS antenna ports used for PDCCH reception may be within a same antenna group or correspond to different antenna groups. For example, in antenna switching-based SRS sounding, the SRS antenna ports mapped for PDCCH reception may be within a same antenna group or across antenna groups. If the SRS antenna ports mapped for PDCCH reception are within a same antenna group, signaling overhead may be reduced by indicating an SRS antenna group. For example, if a first antenna port used to transmit the first SRS 210-a and a second antenna port used to transmit the second SRS 210-b are within a same antenna group, the UE 115-a may transmit the uplink control signal 205 including an indication of that antenna group. For example, the UE 115-a may indicate which two transmit antennas in a two transmit antenna, four receive antenna configuration (e.g., a 2T4R configuration) correspond to the receive antennas used for PDCCH monitoring.

If SRS antenna ports are mapped for PDCCH reception across antenna groups, the uplink control signal 205 may indicate one or more antenna groups and one or more antenna indexes. For example, a first one or more bits may indicate an antenna group including a matched PDCCH receive antenna port, and one or two additional bits may indicate which antenna within the antenna group corresponds to the matched PDCCH receive antenna port.

In some examples, the UE 115-a may change a quantity of receive antennas used to receive downlink signaling, such as downlink PDCCH signaling. For example, the UE 115-a may change from receiving PDCCH signaling using two antenna ports to receiving PDCCH signaling using one antenna port. In some examples, the UE 115-a may dynamically or semi-statically indicate an update for the SRS antenna mapping scheme based on switching the quantity of receive antennas. In some examples, the UE 115-a may indicate the update for the antenna mapping scheme via two-step signaling. For example, the UE 115-a may indicate a quantity of receive antennas used for PDCCH reception, then the UE 115-a may indicate a mapping between SRS antenna ports and PDCCH receive antennas. In some examples, the indication of the quantity of receive antennas and the indication of the mapping may be transmitted together (e.g., in a single transmission) or via separate signaling.

In some examples, the UE 115-a may implicitly indicate a quantity of receive antennas used for PDCCH monitoring. For example, a signaling payload size may implicitly indicate a quantity of antennas the UE 115-a uses for PDCCH monitoring. Using one bit to indicate the mapping between SRS antenna ports and PDCCH receive antennas may implicitly indicate that the UE 115-a is using one antenna for PDCCH monitoring, and using two bits to indicate the mapping between SRS antenna ports and PDCCH receive antennas may implicitly indicate that the UE 115-a is using two antennas for PDCCH monitoring. In other examples, different quantities of bits may be used to implicitly indicate different quantities of antennas used for PDCCH monitoring.

In some examples, the network entity 105-a may configure the UE 115-a with an SRS for PDCCH sounding. The SRS may be a periodic SRS or an aperiodic SRS. A periodicity for the periodic SRS used for PDCCH sounding may be larger than a periodicity of other SRS or larger than a search space periodicity, or both. In some examples, the aperiodic SRS used for PDCCH sounding may be transmitted based on a PDCCH adaptation in time domain. In some examples, the UE 115-a may use a subset of antenna ports when transmitting SRS for PDCCH sounding. For example, the UE 115-a may be configured for four receive antenna ports, and the UE 115-a may transmit the SRS for PDCCH sounding using two of the receive antenna ports. In some examples, the four receive antenna ports may leverage PDSCH channel sounding.

In some other examples, the SRS sounding scheme may support downlink antenna selection for PDCCH monitoring. For example, the SRS sounding scheme may support two transmit antennas, four receive antennas. The network entity 105-a may indicate which two transmit antennas are best or preferred for PDCCH downlink precoding. For example, the network entity 105-a may indicate which transmit antennas correspond to a highest signal quality. In some examples, the UE 115-a may use two corresponding receive antennas for PDCCH monitoring. For example, the network entity 105-a may indicate two transmit antennas which correspond to a highest quality when transmitting the UE 115-a, and the UE 115-a may select two antenna ports that correspond to the two transmit antennas to receive PDCCH signaling from the network entity 105-a.

In some examples, the UE 115-a may transmit capability information associated with PDCCH sounding. For example, the UE 115-a may report capability information for PDCCH precoder selection based on SRS transmission. In some examples, the UE 115-a may indicate whether the UE 115-a has a fixed or dynamic mapping between SRS and PDCCH receive antennas. For antenna switching-based SRS sounding, the UE 115-a may indicate whether the SRS antenna ports mapped to PDCCH receive antennas are within a same antenna group or across antenna groups. In some examples, the UE 115-a may indicate whether the UE 115-a supports SRS for PDCCH receive adaptation. The UE 115-a may indicate a specific sounding scheme for PDCCH receive adaptation. In some examples, the UE 115-a may support a higher quantity of receive antennas for data communications than indicated for the sounding scheme. For example, the UE 115-a may support using eight receive antennas for data signaling, and the UE 115-a may indicate a different, or smaller, quantity of receive antennas (e.g., two antennas) for PDCCH receive adaptation. In some examples, the UE 115-a may indicate support for a one transmit antenna, four receive antenna scheme or a two transmit antenna, four receive antenna scheme for SRS sounding for PDCCH. In some examples, the UE 115-a may report two transmit antennas, eight receive antennas or four transmit antennas, eight receive antennas for downlink precoding.

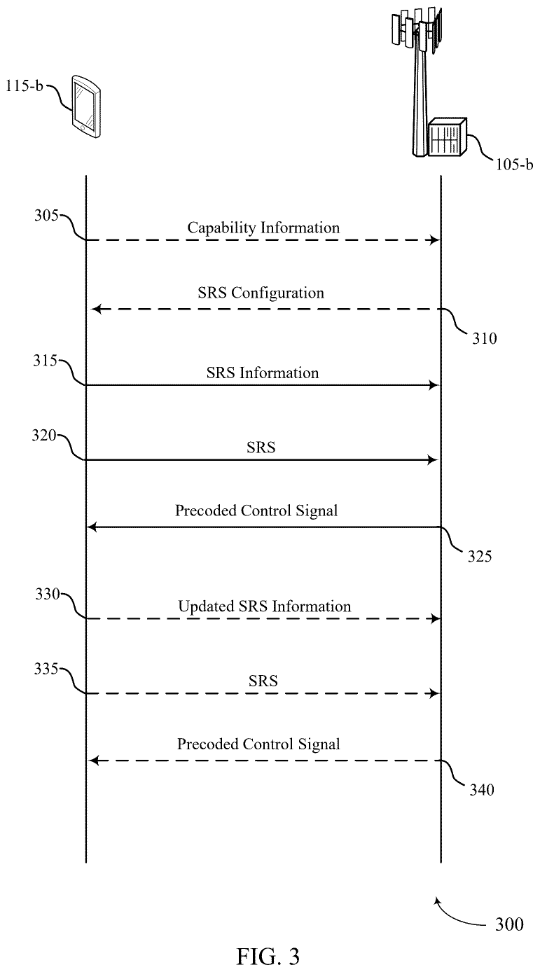

FIG. 3 shows an example of a process flow 300 that supports SRS techniques with receiver antenna adaption in accordance with one or more aspects of the present disclosure. The process flow 300 may implement aspects of a wireless communications system 100 or a wireless communications system 200 as described herein. For example, the process flow 300 may be implemented by a UE 115-b or a network entity 105-b, or both, which may be respective examples of a UE 115 and a network entity 105.

In some examples, alternative examples of the following may be implemented, where some steps are performed in a different order than described or are not performed at all. In some cases, steps may include additional features not mentioned below, or further steps may be added. Although the UE 115-b and the network entity 105-b are shown performing the operations of the process flow 300, some aspects of some operations may also be performed by one or more other wireless devices, network entities, or network devices.

In some examples, the UE 115-b may transmit capability information to the network entity 105-b at 305. For example, the UE 115-b may transmit capability information that indicates a capability of the UE 115-b to use a subset of antenna ports for downlink control channel reception. For example, the UE 115-b may indicate support for downlink receive adaptation or to use a reduced quantity of antennas to receive PDCCH signaling from the network entity 105-b. In some examples, the capability information may indicate a first transmit-receive antenna configuration for a downlink control channel sounding and a second transmit-receive antenna configuration for a downlink shared channel sounding. In some examples, the UE 115-b may indicate a fixed or dynamic mapping between SRS and PDCCH receive antennas. In some examples, the UE 115-b may indicate whether SRS antenna ports are mapped to PDCCH receive antennas within antenna groups or across different antenna groups. In some examples, the UE 115-a may indicate a reduced quantity of transmit antennas for SRS sounding for PDCCH, even though the UE 115-b supports, or reports, a larger quantity of transmit antennas or receive antennas, or both, for PDSCH downlink precoding.

In some examples, at 310, the network entity 105-b may transmit SRS configuration information to the UE 115-b. For example, the network entity 105-b may configure the UE 115-b with an SRS for PDCCH channel sounding. In some examples, the SRS configuration information may configure the UE 115-b to transmit the SRS for PDCCH channel sounding using a subset of antenna ports. For example, the network entity 105-b may indicate a subset of transmit antennas at the network entity 105-b which provide a highest quality for PDCCH downlink precoding, and the UE 115-b may be configured to use two corresponding antennas for PDCCH monitoring or transmission of the SRS for PDCCH channel sounding, or both.

At 315, the UE 115-b may transmit SRS information to the network entity 105-b. For example, the UE 115-b may transmit a control signal that indicates a subset of SRS of a set of SRS. For example, the UE 115-b may transmit an indication of SRS antenna ports that correspond to, or are used as, receive antenna ports for PDCCH monitoring.

In some examples, the control signal may indicate a first antenna group of multiple antenna groups. For example, the antennas of the first antenna group may correspond to SRS antenna ports which are also used for PDCCH monitoring (e.g., when implementing PDCCH receive adaptation). In some examples, the control signal may indicate a first antenna identifier of a first antenna group of multiple antenna groups and a second antenna identifier of a second antenna group of the multiple antenna groups. In some examples, a first quantity of bits in the control signal that indicates the subset of SRS may implicitly indicate a second quantity of antenna ports in a subset of antenna ports.

At 320, the UE 115-b may transmit SRS to the network entity 105-b. For example, the UE 115-b may transmit a set of SRS using a set of antenna ports of the UE 115-b. The subset of SRS may be transmitted using a subset of antenna ports of the set of antenna ports. The network entity 105-b may receive the SRS at 320 and determine a precoder or transmit beam for downlink control channel signaling based on the subset of SRS.

At 325, the network entity 105-b may transmit a precoded control signal to the UE 115-b. For example, the UE 115-b may receive, using the subset of antenna ports used to transmit the subset of SRS, a downlink control channel signal that is precoded according to the subset of SRS. The UE 115-b may receive the downlink control channel signal based on transmitting the set of SRS and the control signal that indicates the subset of SRS.

In some examples, the UE 115-b may transmit updated SRS information at 330. For example, the UE 115-b may transmit a second control signal that indicates an updated subset of SRS of the set of SRS. For example, a mapping between SRS and physical antennas may be changed at the UE 115-b, and the UE 115-b may indicate the updated mapping between SRS and physical antennas, such as the antennas used for PDCCH monitoring, to the network entity 105-b. In some examples, the UE 115-b may transmit SRS at 335. In some examples, the UE 115-b may receive, using an updated subset of antenna ports of the set of antenna ports, the subset of antenna ports corresponding to the updated subset of SRS, a second downlink control channel signal that is precoded according to the updated subset of antenna ports at 340. The network entity 105-b may precode the second downlink control channel signal according to the updated subset of antenna ports based on receiving the second control signal that indicates the updated subset of SRS.

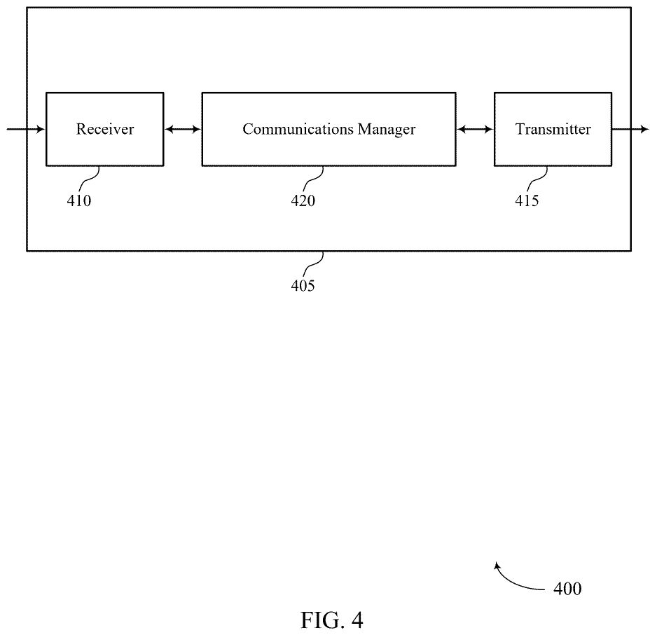

FIG. 4 shows a block diagram 400 of a device 405 that supports SRS techniques with receiver antenna adaption in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to SRS techniques with receiver antenna adaption). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to SRS techniques with receiver antenna adaption). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of SRS techniques with receiver antenna adaption as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for transmitting a control signal that indicates a subset of SRS of a set of multiple SRS. The communications manager 420 is capable of, configured to, or operable to support a means for transmitting the set of multiple SRS using a set of multiple antenna ports of the UE, where the subset of SRS is transmitted using a subset of antenna ports of the set of multiple antenna ports. The communications manager 420 is capable of, configured to, or operable to support a means for receiving, using the subset of antenna ports used to transmit the subset of SRS, a downlink control channel signal that is precoded according to the subset of SRS based on transmitting the set of multiple SRS and the control signal that indicates the subset of SRS.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced power consumption.

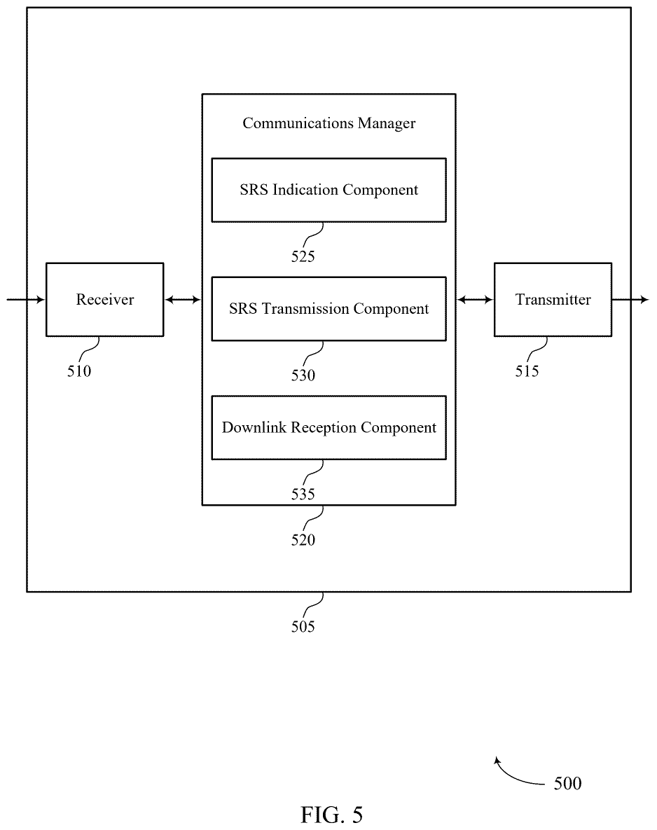

FIG. 5 shows a block diagram 500 of a device 505 that supports sounding reference signal techniques with receiver antenna adaption in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to sounding reference signal techniques with receiver antenna adaption). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to sounding reference signal techniques with receiver antenna adaption). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of sounding reference signal techniques with receiver antenna adaption as described herein. For example, the communications manager 520 may include an SRS indication component 525, an SRS transmission component 530, a downlink reception component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The SRS indication component 525 is capable of, configured to, or operable to support a means for transmitting a control signal that indicates a subset of SRS of a set of multiple SRS. The SRS transmission component 530 is capable of, configured to, or operable to support a means for transmitting the set of multiple SRS using a set of multiple antenna ports of the UE, where the subset of SRS is transmitted using a subset of antenna ports of the set of multiple antenna ports. The downlink reception component 535 is capable of, configured to, or operable to support a means for receiving, using the subset of antenna ports used to transmit the subset of SRS, a downlink control channel signal that is precoded according to the subset of SRS based on transmitting the set of multiple SRS and the control signal that indicates the subset of SRS.

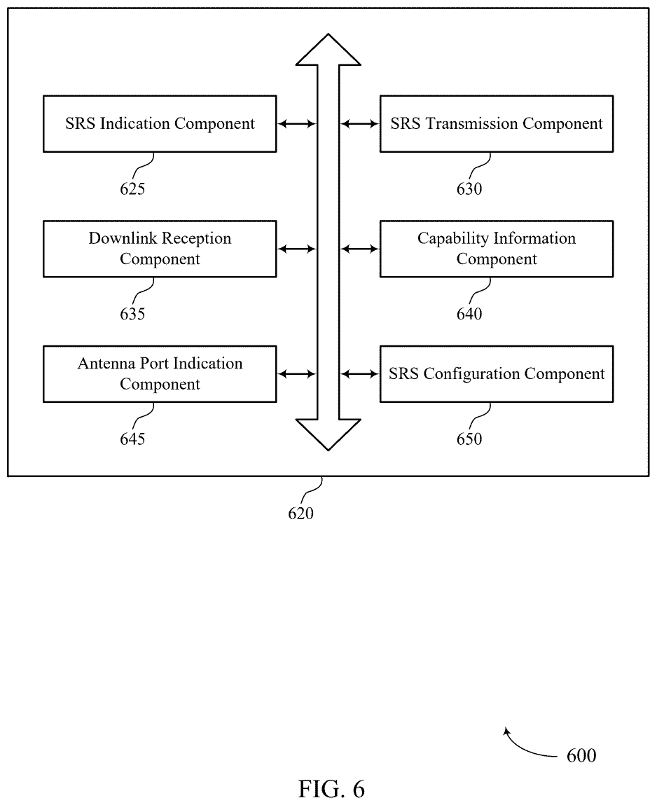

FIG. 6 shows a block diagram 600 of a communications manager 620 that supports sounding reference signal techniques with receiver antenna adaption in accordance with one or more aspects of the present disclosure. The communications manager 620 may be an example of aspects of a communications manager 420, a communications manager 520, or both, as described herein. The communications manager 620, or various components thereof, may be an example of means for performing various aspects of sounding reference signal techniques with receiver antenna adaption as described herein. For example, the communications manager 620 may include an SRS indication component 625, an SRS transmission component 630, a downlink reception component 635, a capability information component 640, an antenna port indication component 645, an SRS configuration component 650, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The SRS indication component 625 is capable of, configured to, or operable to support a means for transmitting a control signal that indicates a subset of SRS of a set of multiple SRS. The SRS transmission component 630 is capable of, configured to, or operable to support a means for transmitting the set of multiple SRS using a set of multiple antenna ports of the UE, where the subset of SRS is transmitted using a subset of antenna ports of the set of multiple antenna ports. The downlink reception component 635 is capable of, configured to, or operable to support a means for receiving, using the subset of antenna ports used to transmit the subset of SRS, a downlink control channel signal that is precoded according to the subset of SRS based on transmitting the set of multiple SRS and the control signal that indicates the subset of SRS.

In some examples, the SRS indication component 625 is capable of, configured to, or operable to support a means for transmitting a second control signal that indicates an updated subset of SRS of the set of multiple SRS. In some examples, the downlink reception component 635 is capable of, configured to, or operable to support a means for receiving, using an updated subset of antenna ports of the set of multiple antenna ports that corresponds to the updated subset of SRS, a second downlink control channel signal that is precoded according to the updated subset of antenna ports based on the second control signal that indicates the updated subset of SRS.

In some examples, the second control signal is transmitted via RRC signaling, uplink control information signaling, or a medium access control (MAC) control element (CE).

In some examples, the capability information component 640 is capable of, configured to, or operable to support a means for transmitting capability information that indicates a capability of the UE to use the subset of antenna ports for downlink control channel reception.

In some examples, the capability information indicates a fixed mapping between the set of multiple SRS and the set of multiple antenna ports.

In some examples, the capability information indicates a first transmit-receive antenna configuration for a downlink control channel sounding and a second transmit-receive antenna configuration for a downlink shared channel sounding.

In some examples, the control signal indicates a first antenna group of a set of multiple antenna groups, the first antenna group corresponding to the subset of SRS.

In some examples, the control signal indicates a first antenna identifier of a first antenna group of a set of multiple antenna groups and a second antenna identifier of a second antenna group of the set of multiple antenna groups.

In some examples, the antenna port indication component 645 is capable of, configured to, or operable to support a means for transmitting a second control signal that indicates a second subset of antenna ports used for downlink control channel reception. In some examples, the downlink reception component 635 is capable of, configured to, or operable to support a means for receiving, using the second subset of antenna ports, a second downlink control channel signal that is precoded according to the second subset of antenna ports.

In some examples, the second control signal indicates a quantity of antenna ports of the second subset of antenna ports.

In some examples, the second control signal indicates a mapping between the set of multiple antenna ports and the set of multiple SRS.

In some examples, a first quantity of bits in the control signal that indicates the subset of SRS implicitly indicates a second quantity of antenna ports in the subset of antenna ports.

In some examples, the SRS configuration component 650 is capable of, configured to, or operable to support a means for receiving control signaling that indicates sounding reference signal configuration information associated with a downlink control channel sounding. In some examples, the SRS transmission component 630 is capable of, configured to, or operable to support a means for transmitting a second subset of SRS using a second subset of antenna ports based on the sounding reference signal configuration information associated with the downlink control channel sounding. In some examples, the downlink reception component 635 is capable of, configured to, or operable to support a means for receiving a second control signal that is precoded according to the second subset of SRS based on transmitting the second subset of SRS.

In some examples, the sounding reference signal configuration information associated with the downlink control channel sounding includes a first sounding reference signal periodicity that is larger than a second sounding reference signal periodicity associated with the set of multiple SRS.

In some examples, the SRS transmission component 630 is capable of, configured to, or operable to support a means for receiving a trigger signal for transmission of the second subset of SRS, where transmitting the second subset of SRS is based on the trigger signal.

In some examples, the control signaling indicates a subset of transmit antenna ports of a network entity, the second subset of antenna ports of the UE corresponding to the subset of transmit antenna ports of the network entity.

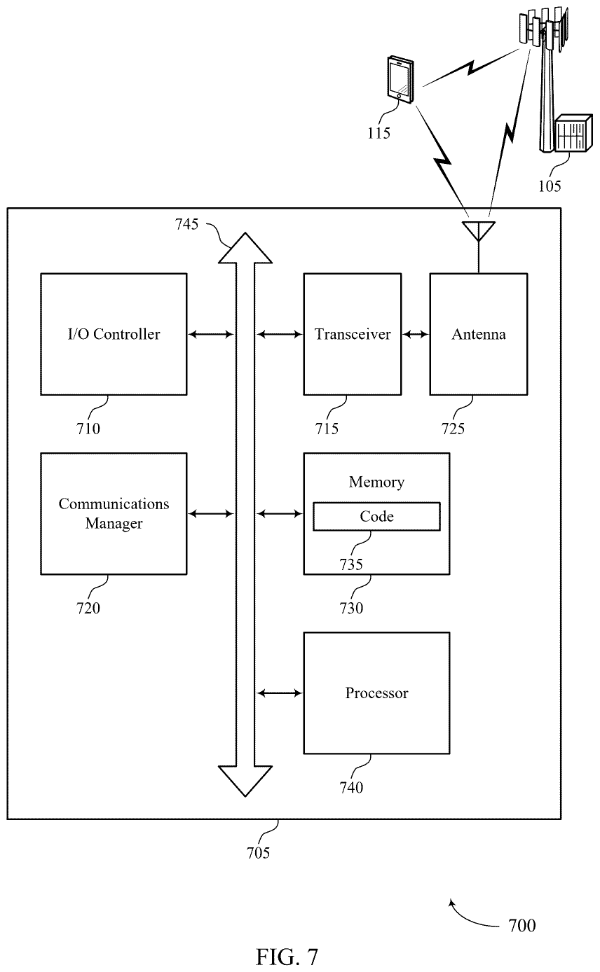

FIG. 7 shows a diagram of a system 700 including a device 705 that supports sounding reference signal techniques with receiver antenna adaption in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting sounding reference signal techniques with receiver antenna adaption). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for transmitting a control signal that indicates a subset of SRS of a set of multiple SRS. The communications manager 720 is capable of, configured to, or operable to support a means for transmitting the set of multiple SRS using a set of multiple antenna ports of the UE, where the subset of SRS is transmitted using a subset of antenna ports of the set of multiple antenna ports. The communications manager 720 is capable of, configured to, or operable to support a means for receiving, using the subset of antenna ports used to transmit the subset of SRS, a downlink control channel signal that is precoded according to the subset of SRS based on transmitting the set of multiple SRS and the control signal that indicates the subset of SRS.

By including or configuring the communications manager 720 in accordance with examples as described herein, the device 705 may support techniques for improved communication reliability, reduced power consumption, and improved coordination between devices.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of sounding reference signal techniques with receiver antenna adaption as described herein, or the at least one processor 740 and the at least one memory 730 may be otherwise configured to, individually or collectively, perform or support such operations.

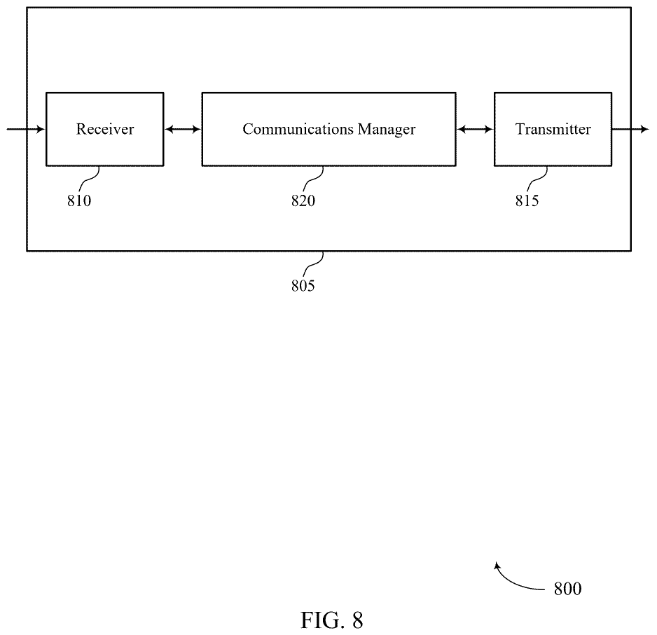

FIG. 8 shows a block diagram 800 of a device 805 that supports sounding reference signal techniques with receiver antenna adaption in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of sounding reference signal techniques with receiver antenna adaption as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for obtaining a control signal that indicates a subset of SRS of a set of multiple SRS. The communications manager 820 is capable of, configured to, or operable to support a means for obtaining the set of multiple SRS, where the subset of SRS is transmitted using a subset of antenna ports of a set of multiple antenna ports of a UE. The communications manager 820 is capable of, configured to, or operable to support a means for outputting a downlink control channel signal that is precoded according to the subset of SRS based on obtaining the set of multiple SRS and the control signal that indicates the subset of SRS.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced power consumption.

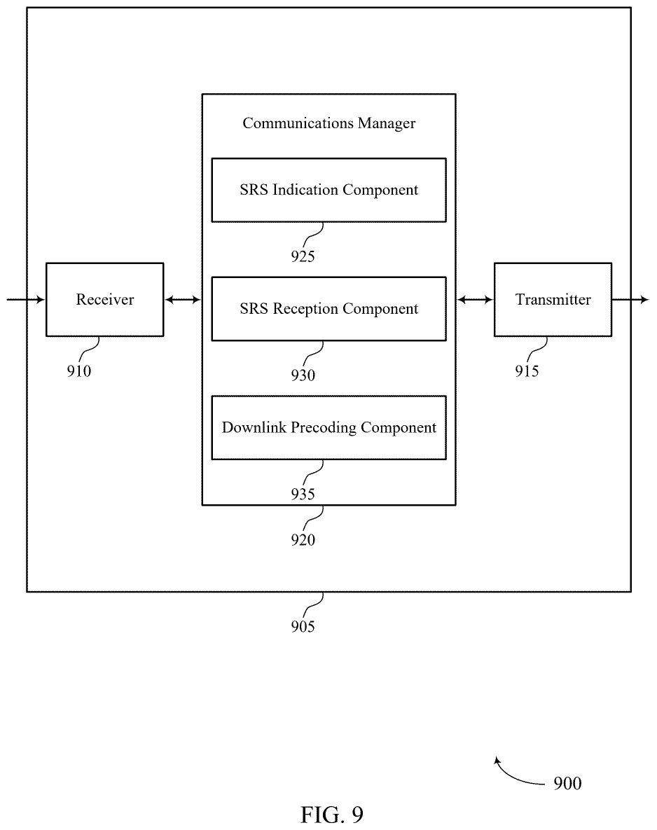

FIG. 9 shows a block diagram 900 of a device 905 that supports sounding reference signal techniques with receiver antenna adaption in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of sounding reference signal techniques with receiver antenna adaption as described herein. For example, the communications manager 920 may include an SRS indication component 925, an SRS reception component 930, a downlink precoding component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The SRS indication component 925 is capable of, configured to, or operable to support a means for obtaining a control signal that indicates a subset of SRS of a set of multiple SRS. The SRS reception component 930 is capable of, configured to, or operable to support a means for obtaining the set of multiple SRS, where the subset of SRS is transmitted using a subset of antenna ports of a set of multiple antenna ports of a UE. The downlink precoding component 935 is capable of, configured to, or operable to support a means for outputting a downlink control channel signal that is precoded according to the subset of SRS based on obtaining the set of multiple SRS and the control signal that indicates the subset of SRS.

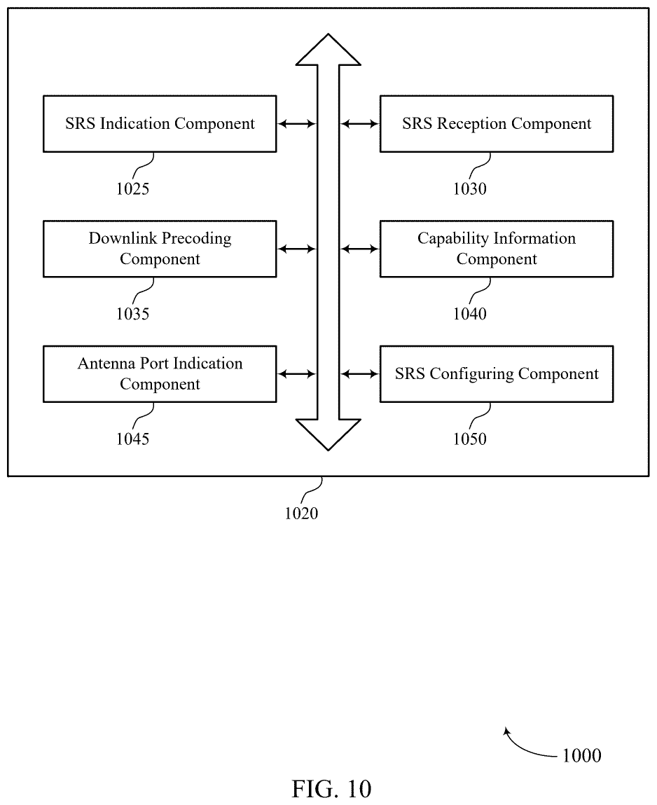

FIG. 10 shows a block diagram 1000 of a communications manager 1020 that supports sounding reference signal techniques with receiver antenna adaption in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of sounding reference signal techniques with receiver antenna adaption as described herein. For example, the communications manager 1020 may include an SRS indication component 1025, an SRS reception component 1030, a downlink precoding component 1035, a capability information component 1040, an antenna port indication component 1045, an SRS configuring component 1050, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The SRS indication component 1025 is capable of, configured to, or operable to support a means for obtaining a control signal that indicates a subset of SRS of a set of multiple SRS. The SRS reception component 1030 is capable of, configured to, or operable to support a means for obtaining the set of multiple SRS, where the subset of SRS is transmitted using a subset of antenna ports of a set of multiple antenna ports of a UE. The downlink precoding component 1035 is capable of, configured to, or operable to support a means for outputting a downlink control channel signal that is precoded according to the subset of SRS based on obtaining the set of multiple SRS and the control signal that indicates the subset of SRS.

In some examples, the SRS indication component 1025 is capable of, configured to, or operable to support a means for obtaining a second control signal that indicates an updated subset of SRS of the set of multiple SRS. In some examples, the downlink precoding component 1035 is capable of, configured to, or operable to support a means for outputting a second downlink control channel signal that is precoded according to the updated subset of SRS based on the second control signal that indicates the updated subset of SRS.

In some examples, the capability information component 1040 is capable of, configured to, or operable to support a means for obtaining capability information that indicates a capability of the UE to use the subset of antenna ports for downlink control channel reception.

In some examples, the capability information indicates a fixed mapping between the set of multiple SRS and the set of multiple antenna ports.

In some examples, the capability information indicates a first transmit-receive antenna configuration for a downlink control channel sounding and a second transmit-receive antenna configuration for a downlink shared channel sounding.

In some examples, the control signal indicates a first antenna group of a set of multiple antenna groups, the first antenna group corresponding to the subset of SRS.

In some examples, the control signal indicates a first antenna identifier of a first antenna group of a set of multiple antenna groups and a second antenna identifier of a second antenna group of the set of multiple antenna groups.

In some examples, the antenna port indication component 1045 is capable of, configured to, or operable to support a means for obtaining a second control signal that indicates a second subset of antenna ports of the UE used for downlink control channel reception. In some examples, the downlink precoding component 1035 is capable of, configured to, or operable to support a means for outputting a second downlink control channel signal that is precoded based on the second control signal that indicates the second subset of antenna ports of the UE.

In some examples, the second control signal indicates a quantity of antenna ports of the second subset of antenna ports.

In some examples, the second control signal indicates a mapping between the set of multiple antenna ports and the set of multiple SRS.

In some examples, the antenna port indication component 1045 is capable of, configured to, or operable to support a means for determining a second quantity of antenna ports in the subset of antenna ports based on a first quantity of bits in the control signal that indicates the subset of SRS.

In some examples, the SRS configuring component 1050 is capable of, configured to, or operable to support a means for outputting control signaling that indicates sounding reference signal configuration information associated with a downlink control channel sounding. In some examples, the SRS reception component 1030 is capable of, configured to, or operable to support a means for obtaining a second subset of SRS based on the sounding reference signal configuration information associated with the downlink control channel sounding. In some examples, the downlink precoding component 1035 is capable of, configured to, or operable to support a means for outputting a second control signal that is precoded according to the second subset of SRS.

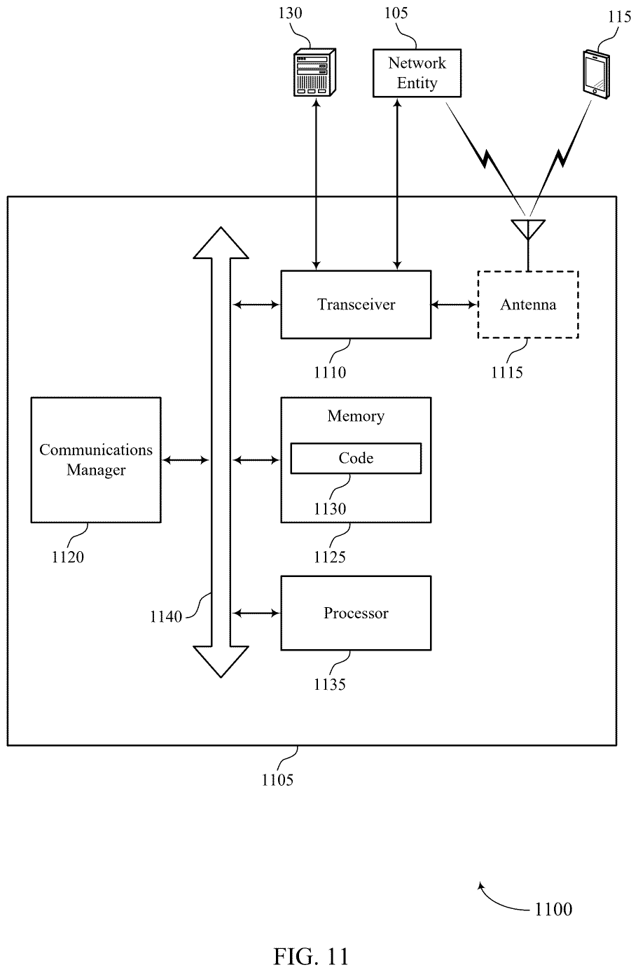

FIG. 11 shows a diagram of a system 1100 including a device 1105 that supports sounding reference signal techniques with receiver antenna adaption in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting sounding reference signal techniques with receiver antenna adaption). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for obtaining a control signal that indicates a subset of SRS of a set of multiple SRS. The communications manager 1120 is capable of, configured to, or operable to support a means for obtaining the set of multiple SRS, where the subset of SRS is transmitted using a subset of antenna ports of a set of multiple antenna ports of a UE. The communications manager 1120 is capable of, configured to, or operable to support a means for outputting a downlink control channel signal that is precoded according to the subset of SRS based on obtaining the set of multiple SRS and the control signal that indicates the subset of SRS.

By including or configuring the communications manager 1120 in accordance with examples as described herein, the device 1105 may support techniques for improved communication reliability, reduced power consumption, and improved coordination between devices.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of sounding reference signal techniques with receiver antenna adaption as described herein, or the at least one processor 1135 and the at least one memory 1125 may be otherwise configured to, individually or collectively, perform or support such operations.

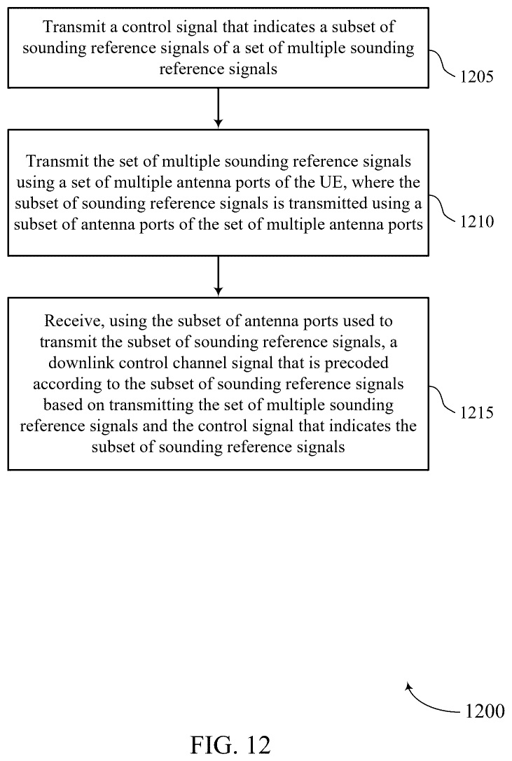

FIG. 12 shows a flowchart illustrating a method 1200 that supports sounding reference signal techniques with receiver antenna adaption in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include transmitting a control signal that indicates a subset of sounding reference signals of a set of multiple sounding reference signals. The operations of 1205 may be performed in accordance with examples as disclosed herein. In some examples, aspects of the operations of 1205 may be performed by an SRS indication component 625 as described with reference to FIG. 6.

At 1210, the method may include transmitting the set of multiple sounding reference signals using a set of multiple antenna ports of the UE, where the subset of sounding reference signals is transmitted using a subset of antenna ports of the set of multiple antenna ports. The operations of 1210 may be performed in accordance with examples as disclosed herein. In some examples, aspects of the operations of 1210 may be performed by an SRS transmission component 630 as described with reference to FIG. 6.

At 1215, the method may include receiving, using the subset of antenna ports used to transmit the subset of sounding reference signals, a downlink control channel signal that is precoded according to the subset of sounding reference signals based on transmitting the set of multiple sounding reference signals and the control signal that indicates the subset of sounding reference signals. The operations of 1215 may be performed in accordance with examples as disclosed herein. In some examples, aspects of the operations of 1215 may be performed by a downlink reception component 635 as described with reference to FIG. 6.

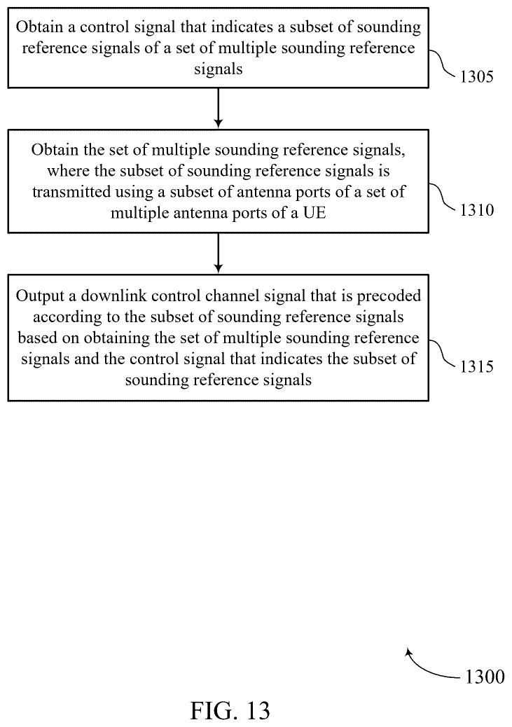

FIG. 13 shows a flowchart illustrating a method 1300 that supports sounding reference signal techniques with receiver antenna adaption in accordance with one or more aspects of the present disclosure. The operations of the method 1300 may be implemented by a network entity or its components as described herein. For example, the operations of the method 1300 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1305, the method may include obtaining a control signal that indicates a subset of sounding reference signals of a set of multiple sounding reference signals. The operations of 1305 may be performed in accordance with examples as disclosed herein. In some examples, aspects of the operations of 1305 may be performed by an SRS indication component 1025 as described with reference to FIG. 10.

At 1310, the method may include obtaining the set of multiple sounding reference signals, where the subset of sounding reference signals is transmitted using a subset of antenna ports of a set of multiple antenna ports of a UE. The operations of 1310 may be performed in accordance with examples as disclosed herein. In some examples, aspects of the operations of 1310 may be performed by an SRS reception component 1030 as described with reference to FIG. 10.

At 1315, the method may include outputting a downlink control channel signal that is precoded according to the subset of sounding reference signals based on obtaining the set of multiple sounding reference signals and the control signal that indicates the subset of sounding reference signals. The operations of 1315 may be performed in accordance with examples as disclosed herein. In some examples, aspects of the operations of 1315 may be performed by a downlink precoding component 1035 as described with reference to FIG. 10.

The following provides an overview of aspects of the present disclosure:
Aspect 1: A method for wireless communications at a UE, comprising: transmitting a control signal that indicates a subset of sounding reference signals of a plurality of sounding reference signals; transmitting the plurality of sounding reference signals using a plurality of antenna ports of the UE, wherein the subset of sounding reference signals is transmitted using a subset of antenna ports of the plurality of antenna ports; and receiving, using the subset of antenna ports used to transmit the subset of sounding reference signals, a downlink control channel signal that is precoded according to the subset of sounding reference signals based at least in part on transmitting the plurality of sounding reference signals and the control signal that indicates the subset of sounding reference signals.
Aspect 2: The method of aspect 1, further comprising: transmitting a second control signal that indicates an updated subset of sounding reference signals of the plurality of sounding reference signals; and receiving, using an updated subset of antenna ports of the plurality of antenna ports that corresponds to the updated subset of sounding reference signals, a second downlink control channel signal that is precoded according to the updated subset of antenna ports based at least in part on the second control signal that indicates the updated subset of sounding reference signals.
Aspect 3: The method of aspect 2, wherein the second control signal is transmitted via RRC signaling, uplink control information signaling, or a medium access control (MAC) control element (CE).
Aspect 4: The method of any of aspects 1 through 3, further comprising: transmitting capability information that indicates a capability of the UE to use the subset of antenna ports for downlink control channel reception.
Aspect 5: The method of aspect 4, wherein the capability information indicates a fixed mapping between the plurality of sounding reference signals and the plurality of antenna ports.
Aspect 6: The method of any of aspects 4 through 5, wherein the capability information indicates a first transmit-receive antenna configuration for a downlink control channel sounding and a second transmit-receive antenna configuration for a downlink shared channel sounding.
Aspect 7: The method of any of aspects 1 through 6, wherein the control signal indicates a first antenna group of a plurality of antenna groups, the first antenna group corresponding to the subset of sounding reference signals.
Aspect 8: The method of any of aspects 1 through 7, wherein the control signal indicates a first antenna identifier of a first antenna group of a plurality of antenna groups and a second antenna identifier of a second antenna group of the plurality of antenna groups.
Aspect 9: The method of any of aspects 1 through 8, further comprising: transmitting a second control signal that indicates a second subset of antenna ports used for downlink control channel reception; and receiving, using the second subset of antenna ports, a second downlink control channel signal that is precoded according to the second subset of antenna ports.
Aspect 10: The method of aspect 9, wherein the second control signal indicates a quantity of antenna ports of the second subset of antenna ports.
Aspect 11: The method of any of aspects 9 through 10, wherein the second control signal indicates a mapping between the plurality of antenna ports and the plurality of sounding reference signals.
Aspect 12: The method of any of aspects 1 through 11, wherein a first quantity of bits in the control signal that indicates the subset of sounding reference signals implicitly indicates a second quantity of antenna ports in the subset of antenna ports.
Aspect 13: The method of any of aspects 1 through 12, further comprising: receiving control signaling that indicates sounding reference signal configuration information associated with a downlink control channel sounding; transmitting a second subset of sounding reference signals using a second subset of antenna ports based at least in part on the sounding reference signal configuration information associated with the downlink control channel sounding; and receiving a second control signal that is precoded according to the second subset of sounding reference signals based at least in part on transmitting the second subset of sounding reference signals.
Aspect 14: The method of aspect 13, wherein the sounding reference signal configuration information associated with the downlink control channel sounding comprises a first sounding reference signal periodicity that is larger than a second sounding reference signal periodicity associated with the plurality of sounding reference signals.
Aspect 15: The method of any of aspects 13 through 14, further comprising: receiving a trigger signal for transmission of the second subset of sounding reference signals, wherein transmitting the second subset of sounding reference signals is based at least in part on the trigger signal.
Aspect 16: The method of any of aspects 13 through 15, wherein the control signaling indicates a subset of transmit antenna ports of a network entity, the second subset of antenna ports of the UE corresponding to the subset of transmit antenna ports of the network entity.
Aspect 17: A method for wireless communications at a network entity, comprising: obtaining a control signal that indicates a subset of sounding reference signals of a plurality of sounding reference signals; obtaining the plurality of sounding reference signals, wherein the subset of sounding reference signals is transmitted using a subset of antenna ports of a plurality of antenna ports of a UE; and outputting a downlink control channel signal that is precoded according to the subset of sounding reference signals based at least in part on obtaining the plurality of sounding reference signals and the control signal that indicates the subset of sounding reference signals.
Aspect 18: The method of aspect 17, further comprising: obtaining a second control signal that indicates an updated subset of sounding reference signals of the plurality of sounding reference signals; and outputting a second downlink control channel signal that is precoded according to the updated subset of sounding reference signals based at least in part on the second control signal that indicates the updated subset of sounding reference signals.
Aspect 19: The method of any of aspects 17 through 18, further comprising: obtaining capability information that indicates a capability of the UE to use the subset of antenna ports for downlink control channel reception.
Aspect 20: The method of aspect 19, wherein the capability information indicates a fixed mapping between the plurality of sounding reference signals and the plurality of antenna ports.
Aspect 21: The method of any of aspects 19 through 20, wherein the capability information indicates a first transmit-receive antenna configuration for a downlink control channel sounding and a second transmit-receive antenna configuration for a downlink shared channel sounding.
Aspect 22: The method of any of aspects 17 through 21, wherein the control signal indicates a first antenna group of a plurality of antenna groups, the first antenna group corresponding to the subset of sounding reference signals.
Aspect 23: The method of any of aspects 17 through 22, wherein the control signal indicates a first antenna identifier of a first antenna group of a plurality of antenna groups and a second antenna identifier of a second antenna group of the plurality of antenna groups.
Aspect 24: The method of any of aspects 17 through 23, further comprising: obtaining a second control signal that indicates a second subset of antenna ports of the UE used for downlink control channel reception; and outputting a second downlink control channel signal that is precoded based at least in part on the second control signal that indicates the second subset of antenna ports of the UE.
Aspect 25: The method of aspect 24, wherein the second control signal indicates a quantity of antenna ports of the second subset of antenna ports.
Aspect 26: The method of any of aspects 24 through 25, wherein the second control signal indicates a mapping between the plurality of antenna ports and the plurality of sounding reference signals.
Aspect 27: The method of any of aspects 17 through 26, further comprising: determining a second quantity of antenna ports in the subset of antenna ports based at least in part on a first quantity of bits in the control signal that indicates the subset of sounding reference signals.
Aspect 28: The method of any of aspects 17 through 27, further comprising: outputting control signaling that indicates sounding reference signal configuration information associated with a downlink control channel sounding; obtaining a second subset of sounding reference signals based at least in part on the sounding reference signal configuration information associated with the downlink control channel sounding; and outputting a second control signal that is precoded according to the second subset of sounding reference signals.
Aspect 29: A UE for wireless communications, comprising one or more memories storing processor-executable code, and one or more processors coupled with the one or more memories and individually or collectively operable to execute the code to cause the UE to perform a method of any of aspects 1 through 16.
Aspect 30: A UE for wireless communications, comprising at least one means for performing a method of any of aspects 1 through 16.
Aspect 31: A non-transitory computer-readable medium storing code for wireless communications, the code comprising instructions executable by one or more processors to perform a method of any of aspects 1 through 16.
Aspect 32: A network entity for wireless communications, comprising one or more memories storing processor-executable code, and one or more processors coupled with the one or more memories and individually or collectively operable to execute the code to cause the network entity to perform a method of any of aspects 17 through 28.
Aspect 33: A network entity for wireless communications, comprising at least one means for performing a method of any of aspects 17 through 28.
Aspect 34: A non-transitory computer-readable medium storing code for wireless communications, the code comprising instructions executable by one or more processors to perform a method of any of aspects 17 through 28.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit a control signal that indicates a subset of sounding reference signals of a plurality of sounding reference signals;
transmit the plurality of sounding reference signals using a plurality of antenna ports of the UE, wherein the subset of sounding reference signals is transmitted using a subset of antenna ports of the plurality of antenna ports; and
receive, using the subset of antenna ports used to transmit the subset of sounding reference signals, a downlink control channel signal that is precoded according to the subset of sounding reference signals based at least in part on transmitting the plurality of sounding reference signals and the control signal that indicates the subset of sounding reference signals.

2. The UE of claim 1, wherein the one or more processors are individually or collectively further operable to execute the code to cause the UE to:
transmit a second control signal that indicates an updated subset of sounding reference signals of the plurality of sounding reference signals; and
receive, using an updated subset of antenna ports of the plurality of antenna ports that corresponds to the updated subset of sounding reference signals, a second downlink control channel signal that is precoded according to the updated subset of antenna ports based at least in part on the second control signal that indicates the updated subset of sounding reference signals.

3. The UE of claim 2, wherein the second control signal is transmitted via radio resource control (RRC) signaling, uplink control information signaling, or a medium access control (MAC) control element (CE).

4. The UE of claim 1, wherein the one or more processors are individually or collectively further operable to execute the code to cause the UE to:
transmit capability information that indicates a capability of the UE to use the subset of antenna ports for downlink control channel reception.

5. The UE of claim 4, wherein the capability information indicates a fixed mapping between the plurality of sounding reference signals and the plurality of antenna ports.

6. The UE of claim 4, wherein the capability information indicates a first transmit-receive antenna configuration for a downlink control channel sounding and a second transmit-receive antenna configuration for a downlink shared channel sounding.

7. The UE of claim 1, wherein the control signal indicates a first antenna group of a plurality of antenna groups, the first antenna group corresponding to the subset of sounding reference signals.

8. The UE of claim 1, wherein the control signal indicates a first antenna identifier of a first antenna group of a plurality of antenna groups and a second antenna identifier of a second antenna group of the plurality of antenna groups.

9. The UE of claim 1, wherein the one or more processors are individually or collectively further operable to execute the code to cause the UE to:
transmit a second control signal that indicates a second subset of antenna ports used for downlink control channel reception; and
receive, using the second subset of antenna ports, a second downlink control channel signal that is precoded according to the second subset of antenna ports.

10. The UE of claim 9, wherein the second control signal indicates a quantity of antenna ports of the second subset of antenna ports.

11. The UE of claim 9, wherein the second control signal indicates a mapping between the plurality of antenna ports and the plurality of sounding reference signals.

12. The UE of claim 1, wherein a first quantity of bits in the control signal that indicates the subset of sounding reference signals implicitly indicates a second quantity of antenna ports in the subset of antenna ports.

13. The UE of claim 1, wherein the one or more processors are individually or collectively further operable to execute the code to cause the UE to:
receive control signaling that indicates sounding reference signal configuration information associated with a downlink control channel sounding;
transmit a second subset of sounding reference signals using a second subset of antenna ports based at least in part on the sounding reference signal configuration information associated with the downlink control channel sounding; and
receive a second control signal that is precoded according to the second subset of sounding reference signals based at least in part on transmitting the second subset of sounding reference signals.

14. The UE of claim 13, wherein the sounding reference signal configuration information associated with the downlink control channel sounding comprises a first sounding reference signal periodicity that is larger than a second sounding reference signal periodicity associated with the plurality of sounding reference signals.

15. The UE of claim 13, wherein the one or more processors are individually or collectively further operable to execute the code to cause the UE to:
receive a trigger signal for transmission of the second subset of sounding reference signals, wherein transmitting the second subset of sounding reference signals is based at least in part on the trigger signal.

16. The UE of claim 13, wherein the control signaling indicates a subset of transmit antenna ports of a network entity, the second subset of antenna ports of the UE corresponding to the subset of transmit antenna ports of the network entity.

17. A network entity, comprising:
one or more memories storing processor-executable code; and
one or more processors coupled with the one or more memories and individually or collectively operable to execute the code to cause the network entity to:
obtain a control signal that indicates a subset of sounding reference signals of a plurality of sounding reference signals;
obtain the plurality of sounding reference signals, wherein the subset of sounding reference signals is transmitted using a subset of antenna ports of a plurality of antenna ports of a user equipment (UE); and
output a downlink control channel signal that is precoded according to the subset of sounding reference signals based at least in part on obtaining the plurality of sounding reference signals and the control signal that indicates the subset of sounding reference signals.

18. The network entity of claim 17, wherein the one or more processors are individually or collectively further operable to execute the code to cause the network entity to:
obtain a second control signal that indicates an updated subset of sounding reference signals of the plurality of sounding reference signals; and
output a second downlink control channel signal that is precoded according to the updated subset of sounding reference signals based at least in part on the second control signal that indicates the updated subset of sounding reference signals.

19. The network entity of claim 17, wherein the one or more processors are individually or collectively further operable to execute the code to cause the network entity to:
obtain capability information that indicates a capability of the UE to use the subset of antenna ports for downlink control channel reception.

20. The network entity of claim 19, wherein the capability information indicates a fixed mapping between the plurality of sounding reference signals and the plurality of antenna ports.

21. The network entity of claim 19, wherein the capability information indicates a first transmit-receive antenna configuration for a downlink control channel sounding and a second transmit-receive antenna configuration for a downlink shared channel sounding.

22. The network entity of claim 17, wherein the control signal indicates a first antenna group of a plurality of antenna groups, the first antenna group corresponding to the subset of sounding reference signals.

23. The network entity of claim 17, wherein the control signal indicates a first antenna identifier of a first antenna group of a plurality of antenna groups and a second antenna identifier of a second antenna group of the plurality of antenna groups.

24. The network entity of claim 17, wherein the one or more processors are individually or collectively further operable to execute the code to cause the network entity to:
obtain a second control signal that indicates a second subset of antenna ports of the UE used for downlink control channel reception; and
output a second downlink control channel signal that is precoded based at least in part on the second control signal that indicates the second subset of antenna ports of the UE.

25. The network entity of claim 24, wherein the second control signal indicates a quantity of antenna ports of the second subset of antenna ports.

26. The network entity of claim 24, wherein the second control signal indicates a mapping between the plurality of antenna ports and the plurality of sounding reference signals.

27. The network entity of claim 17, wherein the one or more processors are individually or collectively further operable to execute the code to cause the network entity to:
determine a second quantity of antenna ports in the subset of antenna ports based at least in part on a first quantity of bits in the control signal that indicates the subset of sounding reference signals.

28. The network entity of claim 17, wherein the one or more processors are individually or collectively further operable to execute the code to cause the network entity to:
output control signaling that indicates sounding reference signal configuration information associated with a downlink control channel sounding;
obtain a second subset of sounding reference signals based at least in part on the sounding reference signal configuration information associated with the downlink control channel sounding; and
output a second control signal that is precoded according to the second subset of sounding reference signals.

29. A method for wireless communications at a user equipment (UE), comprising:
transmitting a control signal that indicates a subset of sounding reference signals of a plurality of sounding reference signals;
transmitting the plurality of sounding reference signals using a plurality of antenna ports of the UE, wherein the subset of sounding reference signals is transmitted using a subset of antenna ports of the plurality of antenna ports; and
receiving, using the subset of antenna ports used to transmit the subset of sounding reference signals, a downlink control channel signal that is precoded according to the subset of sounding reference signals based at least in part on transmitting the plurality of sounding reference signals and the control signal that indicates the subset of sounding reference signals.

30. A method for wireless communications at a network entity, comprising:
obtaining a control signal that indicates a subset of sounding reference signals of a plurality of sounding reference signals;
obtaining the plurality of sounding reference signals, wherein the subset of sounding reference signals is transmitted using a subset of antenna ports of a plurality of antenna ports of a user equipment (UE); and
outputting a downlink control channel signal that is precoded according to the subset of sounding reference signals based at least in part on obtaining the plurality of sounding reference signals and the control signal that indicates the subset of sounding reference signals.
